(19) United States
(12) Patent Application Publication
(10) Pub. No.: US 2003/0115153 A1
(43) Pub. Date: Jun. 19, 2003

(54) Identifier management in message transmission system

(76) Inventors: Chen Li, Irvine, CA (US); Anthony Tomasic, Pittsburgh, PA (US); Andrew Mann, San Francisco, CA (US); Kelly Wilson, Palo Alto, CA (US); Mayank Bawa, Palo Alto, CA (US)

Correspondence Address: FISH & RICHARDSON P.C., 500 ARGUELLO STREET, SUITE 500, REDWOOD CITY, CA, 94063, US

(21) Appl. No.: 10/027,406

(22) Filed: Dec. 19, 2001

(51) Int. Cl. G06F 17/60

(52) U.S. Cl. 705/67

(57) ABSTRACT

The invention provides a system for facilitating communication between two or more sites, where the system comprises an information utility operable to enable communication between a first site and a second site, and a user registration system coupled to the information utility, the user registration system operable to enable the first and second sites to identify users without sharing user information.

### BACKGROUND

This invention relates to managing transactions, and more particularly to managing a user's identity.

The most popular Internet transaction paradigm today is a “one-to-many” paradigm, i.e., one merchant associating with many affiliates. An example of a one-to-many paradigm is Amazon.com and its hundreds of thousands of participating affiliates. The one-to-many paradigm, however, does not work well in the context of local merchants using the Internet as an ordering mechanism for local deliveries because a single local merchant relying on local delivery cannot service a global market. In order for affiliates with global reach to take advantage of local merchants, a network of many merchants must be established where each merchant uses the same affiliate reference protocols. In this context, a many-to-many paradigm (i.e., many merchants associating with many affiliates) is more suitable.

Although it would be desirable to use the many-to-many paradigm in controlling a wide range of Internet or other communications, one particular on-line industry that would benefit from the many-to-many paradigm is the online grocery industry. Global affiliates such as marthastewart.com offer content, such as recipes, related to the on-line grocery industry. In a many-to-many paradigm, multiple content sites such as marthastewart.com could be linked to multiple on-line grocery services, such as Peapod. The many-to-many paradigm would enable a user to view recipes from various content sites and to order local items needed to prepare the dishes while at the same time limiting the number of transactions required from the user.

Extrapolating the one-to-many model to the many-to-many model results in prior art system 100 illustrated in FIG. 1. In FIG. 1, a user may access a typical content site (such as marthastewart.com 1a) to obtain a recipe and may then access an online grocery/merchant site (such as Peapod 2a ) to purchase the products needed to make the dish. In the system 100, two or more separate transactions (up to one for each item of the recipe) are required to purchase products for a recipe or to perform any function requiring accessing two or more sites. And, in order for every site to have access to every content site and vice versa, every merchant site must have direct access to every content site.

In an improved many-to-many network, each site has access to every other site through an intermediary. The improved many-to-many network increases the total number of sites accessible by each other site, without requiring direct connections between the sites. In the grocery example, the improved many-to-many network would allow a user to add items from multiple recipes on content sites directly into the user's on-line grocery basket.

While the many-to-many paradigm is not new, effective many-to-many systems are going to have to address the issue of reconciling user identifications across sites. Often sites provide services which are personalized. For example, a content site might make its information available only to its members. And, a merchant site may need to know the identity of its user before a transaction can be carried out. This means that user identity (which may not be homogeneous) must be established at and reconciled between each site accessed by the user.

Current methods for identifying and managing user identities employ an algorithm to construct a relation M(a,b), where A and B are sets of records representing a user at each of two sites and the relation M(a,b) is populated with the record identifiers from A appearing in attribute a and those of B appearing in attribute b. M(a,b) is constructed by comparing the fields of records containing information about the user such as social security number, first and last name, address, zip code, etc.

These current algorithms have three disadvantages. First, a high level of trust must exist between the two sites, since users are typically customers and thus sharing user information is tantamount to sharing coveted customer lists. Second, existing algorithms build relation M(a,b) off-line and thus do not present the advantages of constructing M(a,b) dynamically—e.g., incrementally adding users and incrementally constructing M(a,b). Third, algorithms that build M(a,b) are error prone, since the information underlying the automatic analysis of fields is incomplete. Current error rates are reported in the 1% to 5% range—too high for many applications.

It would be desirable to have a system for identifying and managing user information between sites that would enable seamless access between sites without requiring sites to share or reveal user information. The sites would associate multiple user identifications with a single user. Thus, what is needed is a double-blind way to identify and manage user identity across heterogeneous and autonomous applications.

### SUMMARY

In one aspect, the invention provides a system for facilitating communication between two or more sites, where the system comprises an information utility operable to enable communication between a first site and a second site, and a user registration system coupled to the information utility, the user registration system operable to enable the first and second sites to identify users without sharing user information.

Aspects of the invention can include one or more of the following advantages. The information utility enables transactions between sites while maintaining the privacy of user information. Because the information utility is on-line, the information utility enables M to be built incrementally. The information utility is accurate because each tuple of M is built by the user completing an authorization protocol. The information utility allows the user to control the flow of the user's personal information.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a diagram of a prior art one-to-many network.

FIG. 2 is a diagram of a many-to-many network.

FIG. 3a is a diagram of a portion of a many-to-many network, accessible by a user browser.

FIG. 3b is a flow chart illustrating the flow of data in the many-to-many network of FIG. 3a.

FIG. 4a is a snapshot of exemplary content to be displayed on a new user's screen when the user is accessing a content site.

FIG. 4b is a snapshot of exemplary content to be displayed on a registered user's screen when the user is accessing a content site.

FIG. 4c is a snapshot of an exemplary registration screen.

FIG. 5 is a snapshot of exemplary content to be displayed on a user's screen when the user is accessing a merchant site.

FIG. 6 is a flow diagram of an information utility accessible from one or more user browsers.

FIG. 7 is a flow chart illustrating the user registration process at a merchant site.

FIG. 8 is a flow chart illustrating the user registration process at a content site.

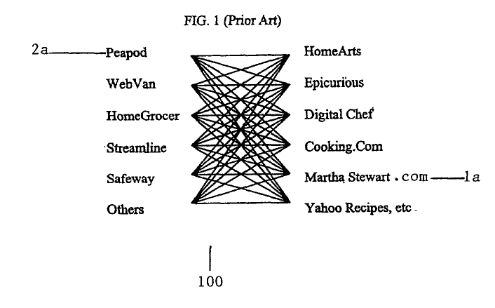

Like reference symbols in the various drawings indicate like elements.

### DETAILED DESCRIPTION

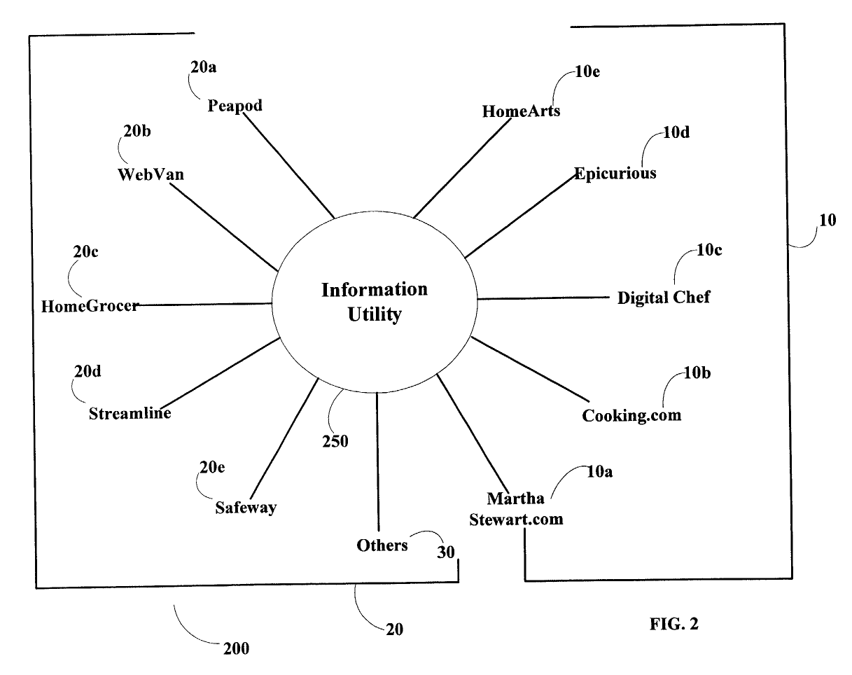

Referring to FIG. 2, in many-to-many network 200, an information utility 250 is connected to one or more content sites 10a-e and one or more merchant sites 20a-e and one or more other sites 30, where the content sites 10 may provide recipes, financial information, travel brochures, news articles, etc. and the merchant sites 20 are, for example, on-line grocery providers, providers of stocks, providers of airline tickets, etc. A content site is any site that provides information; a merchant site is any site capable of accepting a transaction. A single site may be both a content site 10 and a merchant site 20. In one aspect, the many-to-many network 200 is designed to allow a user to use information obtained from a content site 10 to issue a transaction at a merchant site 20.

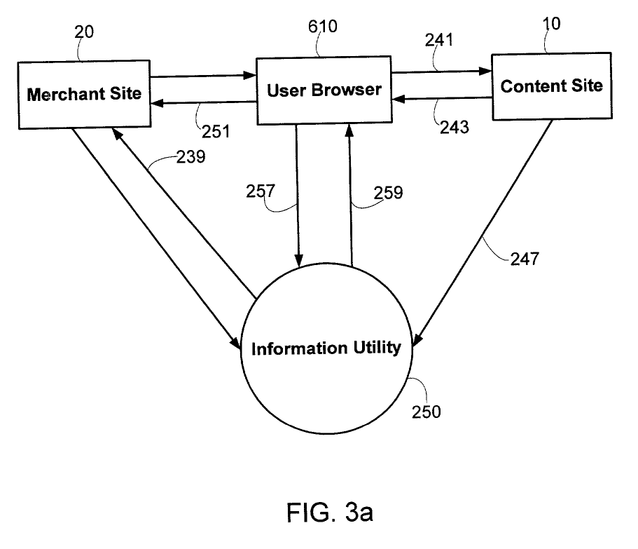

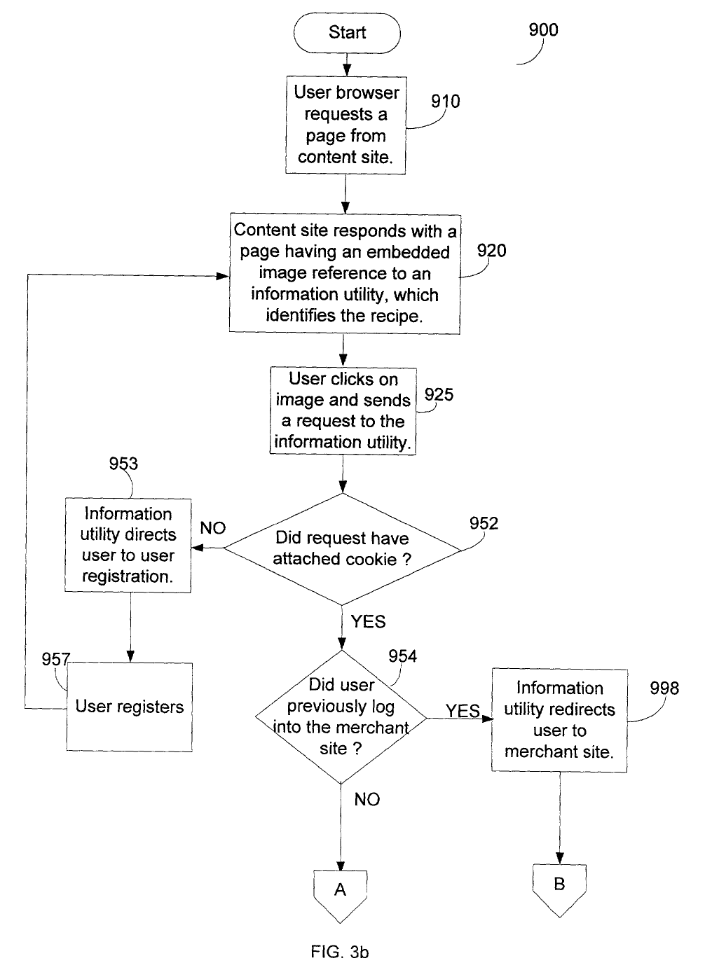

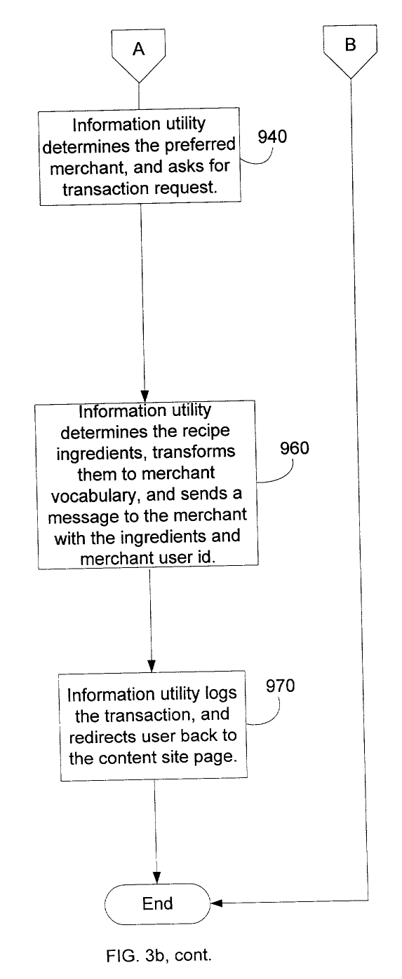

Referring to FIGS. 2 and 3a, the information utility 250 acts as a mediator between the different sites 10a-10e, 20a-20e, and 30, which are not moved from their existing locations. The information utility 250 is responsible for resolving the heterogeneity across all sites 10a-10e, 20a-20e, and 30, and forms the central hub. Only the catalogs of each site 10a-10e, 20a-20e, and 30 are replicated at the information utility 250. These catalogs are mapped to a universal catalog. When a user browser 610 directs a site 10a-10e, 20a-20e, or 30 to communicate with another site 10a-10e, 20a-20e, or 30, a message is sent from a source site to a destination site, via the information utility 250. The information utility 250 intercepts the message, and transforms the message from the vocabulary of the source site, to the vocabulary of the destination site.

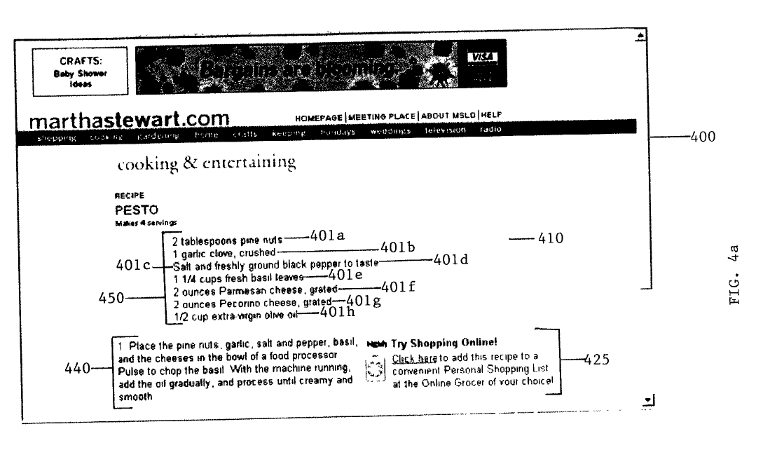

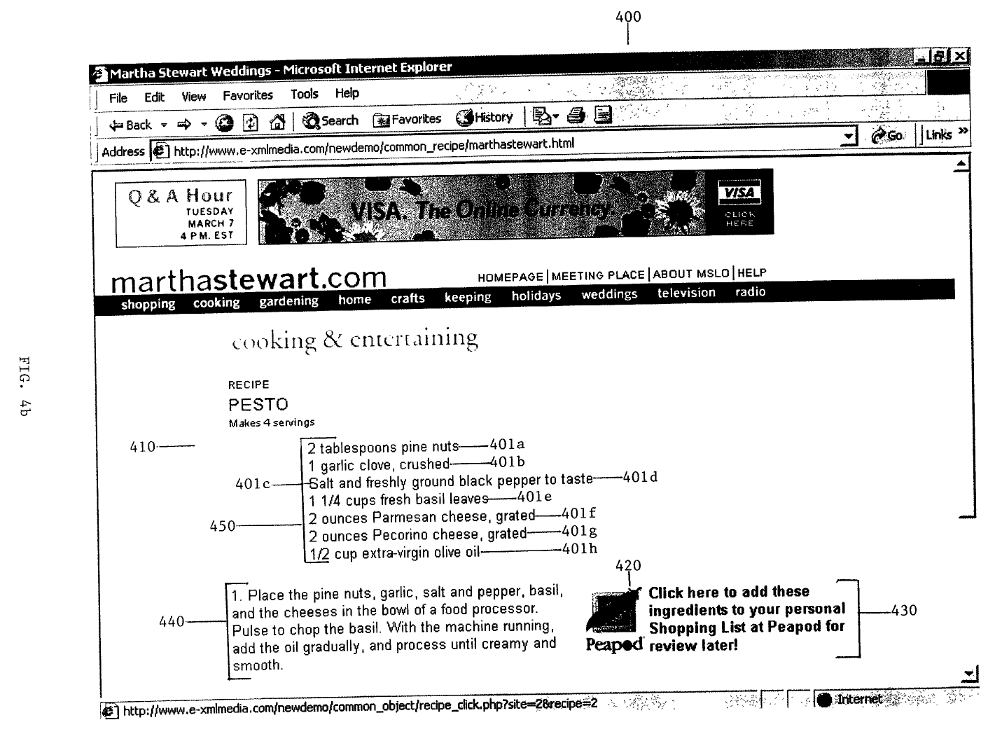

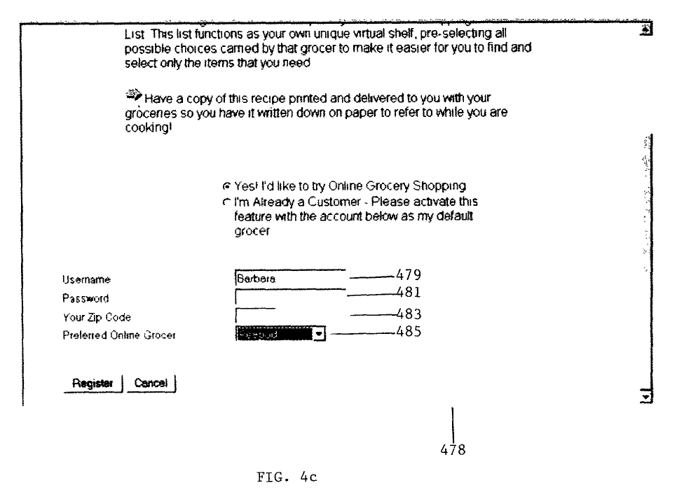

For example, referring to FIGS. 3a, 4a and 4b, a user may access marthastewart.com 10a in search of a recipe. The Martha Stewart page 400 features a recipe 410 with preparation instructions 440, and ingredients 401a-h, collectively 450. If the user is already a user of Peapod, a merchant icon 420 representing Peapod and a shopping icon 430 are displayed.

Similarly, if the user is a HomeGrocer 20c user, the information utility 250 recognizes the HomeGrocer cookie and places a merchant icon 420 with the HomeGrocer logo instead. Likewise for other merchants that are users of the information utility 250. In the event the user is a user of more than one merchant site 20a-20e, the information utility 250 may either default to the most recently used account, allow the consumer to select from multiple logos in a single image map, push traffic to a preferred merchant site 20a-20e per negotiated agreement, or utilize user profile information to select one or more merchants 20.

If the user is not a recognized user of the information utility 250, information utility 250 may provide the user with the option of registering. The option may be presented by icon 425: “Try Shopping On-Line.” If the user is a recognized user of information utility 250, but is not a recognized user of any merchant, the information utility 250 may look for any other identification codes indicative of geography (a Martha Stewart identifier or other method) to determine the correct logo to offer or, barring any geographic identifier, the information utility 250 may require the entry of a zip code and may present an icon based on the zip code.

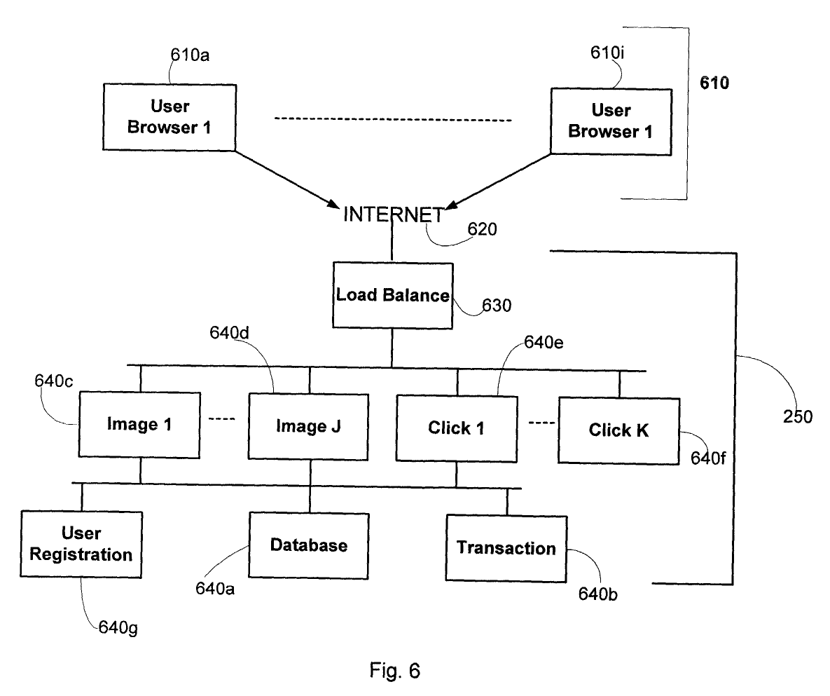

In one respect, the recipe 410 has a code assigned to it and that code is placemarked in the database 640a of FIG. 6. When the user accesses the recipe 410 on the content site 10, the recipe code is sent to the information utility 250 via path 247 (with the merchant site 20 and user destination code attached). The information utility 250 maintains a database (640a, FIG. 6) of each recipe accessed by the user. The recipes accessed by the user as stored as part of a user log U also maintained in database 640a.

In another respect, the information utility 250 aggregates each ingredient and maps each ingredient to merchant ingredient codes supplied to the information utility 250 from the merchant site 20. When the user clicks the shopping icon 430, a small pop-up confirmation window may state: “The ingredients have been transferred to your Shopping Idea List at Peapod for your review before purchasing, and will be aggregated and saved with ingredients from whatever other recipes you choose. For your convenience we have also saved each recipe ingredients and quantities required in your “My Recipes” notebook at Peapod. Scaling up or down quantities for different number of servings is a snap—just use the scaling tool provided when placing your order at Peapod.” (message not shown) Affiliate identifiers are sent to the merchant site 20 via path 239, triggering a confirming message when the user logs into the merchant site 20. The user never leaves marthastewart.com 10a and can continue browsing and clicking.

After clicking on several recipes at marthastewart.com 10a, Digital Chef 10c, and Epicurious 10d, the user may access Peapod 20a via path 251 to complete the order. After signing in, the user may receive a confirmation message “Since you were here last, we have added ingredients to your shopping list from the recipes you chose at Martha Stewart, Digital Chef, and Epicurious. Click on the ‘Shopping List’ to review and order the ingredients you would like to purchase.” (message not shown). The Peapod 20a may also provide the user options: “Review & Add Ingredients from Shopping List”, and “My Recipes” (both with associated icons) (not shown).

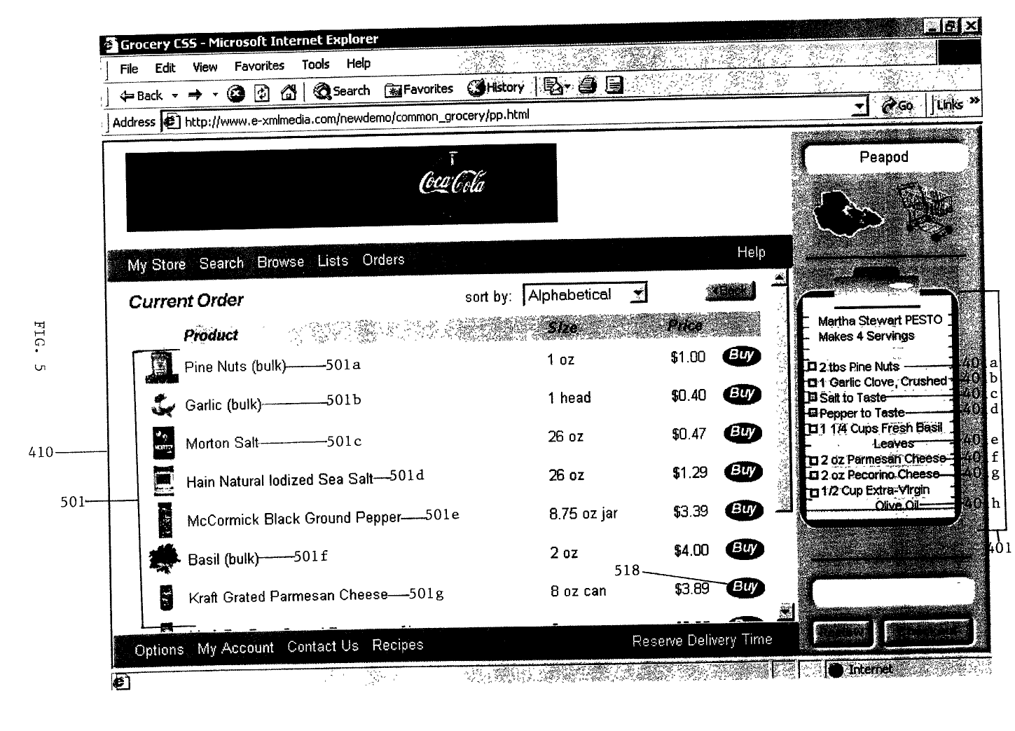

When a user clicks “Shopping List,” he or she may have the option of viewing two windows side by side: a left window with a list of each recipe name and number of servings, followed by aggregate quantities of each generic item required (i.e. 2 quarts Milk—which has calculated out the amount of milk necessary to fill all 5 recipes plus the meal plan) and check off boxes; and a right window listing items carried by Peapod that match, including choices for some of the items (i.e. Nonfat Milk, 1% Milk, and 2% Milk), with click to buy buttons. The view would be the corollary to the view shown in FIG. 5. The user may review the list, selects ingredients to purchase, and (at the user's option) place a check mark by each item on the left list to remind him or her what he or she has already selected. When the user is finished, the user may click to close the box and may receive a confirmation message “Would you like to clear the contents of your List to leave it empty for the next time?” with the options “Yes—throw away old list” and “No—save list I'm not finished with it yet.”

The user may also have the ability to review the abbreviated version of each recipe that he or she chose. In the event a recipe calls for items that are not carried by the merchant, the information utility 250 may deliver a prompt notifying user which items were not available and suggesting other merchants in the network that can complete the user's request.

Alternatively, referring to FIG. 5, upon accessing the merchant site Peapod 20a to complete an order, the user may be presented with a view of Peapod grocery items 501a-501g in a left view and one or more menus 410, including ingredients 401 in a right view. The user may be given the option to purchase (using the click to buy buttons 518) each of the items on the shopping cart 501.

Referring to FIG. 6, a high level overview of the information utility 250 architecture is shown from a data flow point of view. A typical commercial site has a number of identical servers which share the load imposed on the site. User browsers 1 (610a) through I (610i) issue requests across the Internet 620. Browser requests are routed through a load balancer 630, which ensures that the requests are distributed evenly across the servers. The information utility 250 has four different sets of servers: database server 640a, transaction management server 640b, image servers 640c-d and click servers 640e-f, as well as a user registration server 640g. The database server 640a stores the persistent state of the various entities in the system: catalogs, logs, user data, etc. The database server 640a is a data base management system that contains the images displayed at the content sites, maintains user profiles (including, for example, the user identification, the current state with respect to the set of transactions issued by the user, and other information), contains the information required to translate the content request into the internal information utility 250 representation, contains the information required to translate the internal information utility 250 representation of a request into a transaction at the merchant site, and contains the images displayed at the merchants. The content images may include images to ‘add items’ for each merchant, an image to register new users, and an image to visit a merchant site.

The database server 640a maintains a comprehensive relational database of all items carried by all merchants, cross-referenced with a variety of qualifying codes, including size, geographic availability (zip code), price, item category code, and substitution class codes. By virtue of creating one standard format, recipe writers will not need to post separate recipes for separate merchants—recipes will refer to a single code which the central server will parse the order according to pre-established rules and logic maintained by the information utility 250 in the database server 640a/transaction management server 640b. The database server 640a contains the information required to translate the content request into the internal information utility 250 representation and a contents request representation. The content request representation and the internal representation may be the same. The database server 640a contains the information required to translate the internal information utility 250 representation of a request into a transaction at the merchant site. This database contains a mapping from every object in the internal representation to a specific merchant SKU or to the error SKU. Error SKU requests are dropped before the transaction is sent to the merchant. These dropped items may be maintained, permitting the user to transmit them to other merchants by default.

The transaction management server 640b has mapping rules for each site, and serves to transform the messages from the content-site vocabulary to that of the merchant site 20. The transaction management server 640b accepts user requests, translates them, and issues the appropriate transaction request at the merchant site 20f. Translation is done with the following steps: (i) the content site request is fetched according to the content site identification and page identification, (ii) the content site request is translated into the information utility 250 internal representation, (iii) the user is allowed to edit the request, (iv) the internal representation is translated into the merchant transaction form; and (v) the transaction is submitted to the merchant site 20. The merchant used depends on the user profile. The content site request is a set of objects representing categories or products. The internal representation is the same as the content site request representation. The merchant transaction form consists of a set of tuples. Each tuple contains the user identification and the SKU of the merchant product. (The user identification may need to be mapped to the merchant user identification.)

The image servers 640c-d are dedicated to generating images corresponding to the various user requests, and serving them. Each image server 640c-d may contain a content image handler for detecting that the user is registered with a merchant site 20 and for displaying the appropriate image, and a merchant image handler for deciding which image to display at the merchant site 20. Note that the images may be personalized for users, and hence may be generated dynamically. The click servers 640e-f handle click through, which corresponds to a user directed message from the content site 10 to the merchant site 20. Each click server 640e-f may contain a content click handler and a merchant click handler. The content click handler routes the user click to the appropriate component, such as 640a-d and 640g. The content click handler routes the user click to the user registration server 640g for new users, to the transaction management server 640b for transactions, or to the merchant site 20 if the transaction has been processed. The merchant click handler routes the user request at the merchant site 20 to the appropriate component, such as 640a-d or 640g.

The load balancer 630 ensures that subsequent interactions between a User Browser I (610i) and a server Image J 640d or Click K 640f are consistent, that is a particular browser 610a or 610i continues to interact with a particular server 640a-g. This functionality permits a particular server 640a-g to efficiently cache information about the “session” of a particular user browser 610a and 610i. During processing of the above protocols, the image severs 640c-d and click servers 640e-f issue requests to the database server 640a and the transaction management server 640b. User registration server 640g registers users with the information utility 250 as described in more detail below. User security for registration with a merchant site 20 is handled by processing the registration at the merchant site 20. The information utility 250 does not necessarily maintain user information. Instead, the cookie in the user browser 610 is sufficient for information utility processing.

Optimally included in the information utility 250 are auditing and accounting servers for tracking activity handled by the information utility 250, a user order modify page for permitting the user to modify his or her transaction before it is sent to the merchant site 20, a content translation editor for managing the contents of a content translation portion of the database server 640a, and a merchant translation editor for managing the contents of the merchant translation portion of the database server 640a. The auditing & accounting server may track activity handled by the information utility 250. This auditing & accounting server may log (i) each page rendered by the image servers 640c-d, (ii) each new registered user/merchant pair, (iii) each transaction submitted on behalf of a user, and (iv) the contents of the transaction submitted. In addition, the information utility 250 may accept transactions from the merchant that record purchases at the merchant site 20. The user order modify page may permit the user to modify his or her transaction before it is sent to the merchant site 20. The modification system may allow the user to delete objects from the transaction, and may permit substitution of items. The content translation editor may manage the contents of the content translation portion of the database 640a. Requests are sets of object identifiers. The merchant translation editor manages the contents of the merchant translation portion of the database 640a. This editor allows modification of the one-to-one mapping of internal object representation identifiers and merchant SKUs.

A user can either access a content site 10 or merchant site 20. For example, a new user may visit the merchant site 20f. When rendering the page for the user, the image server (for example, the merchant image handler of Image 1 640c) determines that this user is new and displays a user registration box (not shown). A cookie is dropped on the user browser 610 at this time. The user selects an option on the user registration box and is routed by the click server (for example, the merchant click handler of Click 1, 640e) to the user registration system 640g. The user registration system 640g registers the user with the information utility 250. At a later time, the user may visit a content site 10. The user selects the image and is routed by the content click handler 941 to the transaction management server 640b. The transaction management server 640b translates the request associated with the content page 10 into the appropriate transaction for the associated merchant site 20. The transaction is issued to the merchant site 20 and the webpage is redisplayed. Upon redisplay, the content image handler of 640c or d detects that the user has issued a transaction and displays the appropriate image. At a later time, the user visits the merchant site 20 and sees the result of the transaction.

Users are registered with the information utility 250 system in three ways—via the content site, via the merchant site, and via identification as a user from a merchant site download. Because information utility 250 serves as an intermediary between user browser 610a or 610i and one or more sites 10a-10e, 20a-20e and 30, information utility 250 can perform the role of user identification reconciliation and management. For example, if a user accesses marthastewart.com 10a to review a recipe, and if the user accesses Peapod 20a via marthastewart.com 10a, information utility 250 may serve as an intermediary to identify and manage the user's information as between the two sites 10a and 20a.

The information utility 250 matches user records by constructing the relation P(ci,mi,mui), where ci is the information utility 250 identifier assigned to the user and stored in the information utility cookie, mi is the merchant identifier stored in the database server 640a, and mui is the merchant user identifier also stored in the database server 640a. P(ci,mi,mui) maps a user to a merchant site 20 and to a user identifier (mui) recognizable by the merchant. The natural self-join of P with itself on attribute ci constructs the relation M.

Each tuple of P is the result of a user completion of an authentication protocol with the associated merchant, as described in the USER REGISTRATION section below. When a transaction is delivered to a merchant mi, the associated user identifier mui is also delivered allowing the particular merchant to recognize the user. Once the relation P is established, the use of P is determined by the user visiting the merchant site 20 or the content site 10, invoking the USER IMAGE DELIVERY AND TRANSACTION PHASE.

User Image Delivery and Transaction Phase

Referring first to the user image delivery phase, and referring to FIGS. 3a and 3b, a user may access either a merchant site 20 or content site 10 via a user browser 610 such as Microsoft Internet Explorer or Netscape Navigator. However, the invention is not limited to use of a browser. The invention applies equally to the use of wireless devices. If the user accesses the content site 10, the user browser 610 first requests an HTML (Hypertext Markup Language) page from the content site 10 by generating an HTTP (Hypertext Transfer Protocol) message (path 243). (910) The content site 10 responds with an HTML page having an embedded image reference to information utility 250, which identifies the recipe (path 241). (920) If wireless devices are employed, a wireless access protocol may be used instead of HTTP.

Next, the user clicks on the embedded image and sends a request to the information utility 250. For example, the user browser 610 may request the recipe image from the information utility 250 via path 257 and may send the information utility 250 an information utility cookie if the user is a registered user. (930). For example, the user browser 610 requests the recipe image from the image server (for example content image handler of Image 1, 640c, FIG. 6) component of the information utility 250 via the HTML fragment:

<img src=“contentimage.informationutility.com?content=4&recipe=5”>

where 4 is an example pre-assigned content identifier and 5 is a pre-assigned recipe identifier.

Next, the information utility 250 determines if the request has an attached information utility 250 cookie (informationutility-id=3). The information utility cookie is a piece of information generated by the information utility 250 and stored in the user's browser 610. The information utility cookie is embedded in the HTTP information flowing back and forth between the user's browser 610 and the information utility 250. The information utility cookie consists of user-specific information transmitted by the information utility 250 onto the user's browser 610 enabling the user-specific information to be available for later access by the information utility 250.

Assuming that the user has previously registered with the information utility 250 (and thus that the request did have an attached information utility 250 cookie), the information utility 250 uses the information provided in the information utility cookie to determine if the user previously logged into the merchant site 20 (954). If the user did previously log into the merchant site 20 (954), the information utility 250 redirects the user to the merchant site 20 (998). If the user did not previously log into the merchant site 20 (954), then the information utility 250 determines which merchant site 20 the user prefers, and requests a transaction request from the user path 259. (940) For example, as shown in FIG. 4b, the information utility 250 may identify Peapod as the preferred merchant site 20 and may ask the user for a transaction request by providing the shopping icon 430: “Click to add some or all Ingredients to your Peapod Shopping List.”

For example, the image server (for example, the content image handler of Image 1, 640c, FIG. 6) determines the preferred merchant site 20 by examining a relation P(ci,mi,mui). In addition, a user log relation U is examined to determine if the user has previously chosen the requested recipe, where the log relation U, stored in the database server 640a of FIG. 6, stores the state of the user activity. If the user log U shows that the user has requested a transaction, the shopping icon 430 will indicate, for example, “Your ingredients were added to your Peapod shopping cart.” An image server (for example, content image handler Image 1, 640c, FIG. 6) replies to the message from the user browser 610 by delivering the appropriate image, e.g., the Martha Stewart page 400, including recipe 410, merchant icon 420, and shopping icon 430 of FIG. 4b.

Next, the user may issue a transaction by sending a request to information utility 250 with his or her information utility cookie. The user may click through on the image (e.g., shopping icon 430), sending a request to a click (for example, the content click handler of Click 1, 640e, FIG. 6) component via

<a href=“contentclick.informationutility.com?content=4&recipe=5”>

with the associated cookie (informationutility-id=3). The click server (for example, the content click handler of 640e) again determines the preferred merchant site 20 based on the user identifier in the information utility cookie, and determines the recipe by examining the URL (Uniform Resource Locator) of the content site 10. The click server (for example, the content click handler of 640e) then fetches the associated recipe from the information utility 250 catalog stored in the d database server 640a of FIG. 6.

The recipes stored in the information utility 250 catalog may be sets of tuples of ingredients, for example:

(recipe=5, item=“pine nuts”, quantity=2, unit=“tablespoon”)

(recipe=5, item=“garlic”, quantity=1, unit=“clove”).

The information utility 250 determines the recipe ingredients, transforms them to merchant site 20 vocabulary, and sends a message to the merchant site 20 with the ingredients and merchant user identifier (mui). (960) The click server (for example, the content click handler of Click 1, 640e, FIG. 6) passes the recipe to the transaction management server (FIG. 6, 640b) to transform the recipe into an asynchronous message for the merchant transaction. (For example, the asynchronous message traveling on path 239 of FIG. 3a). The asynchronous message is then sent to the preferred merchant site 20. The message contains user identifier (mui) and the SKUs for products that correspond to ingredients in the recipe. The SKUs are specific to the merchant site 20. For example, the message may contain:

(merchant-user-id=2, item(quantity=1, sku=“pppn”), item(quantity=1 sku=“ppg”), . . . )

where “pppn” is the SKU for an ounce of pine nuts at Peapod 20a, “ppg” is the SKU for a clove of garlic, etc. The transaction management server 640b, FIG. 6 receives the message and effects the appropriate transaction to create the shopping cart 501, as shown in FIG. 5.

To acknowledge the user's issuance of a transaction at the merchant site 20, the information utility 250 logs the transaction, and redirects user back to the content site 10. (970) The user is redirected to the content site 10 containing the same recipe. In addition, a tuple (informationutility-id=3, content=4, recipe=5) is inserted into the user log relation U.

User Registration

Referring next to the user registration phase, as described above, in order for the information utility 250 to effect transactions between two sites such as content site 10 and merchant site 20, the information utility 250 must reconcile and manage the user's identity. Thus, prior to entering the USER IMAGE DELIVERY AND TRANSCATION PHASE, the user must first register with the information utility 250 and any preferred merchants 20. A user may register either through a content site 10 or a merchant site 20. In either case, the user registration phase establishes an information utility user identifier (ci) in a cookie in the user browser 610 and a mapping between this identifier and the identifier at a particular merchant site 20 (mui).

User Registration Phase-Merchant

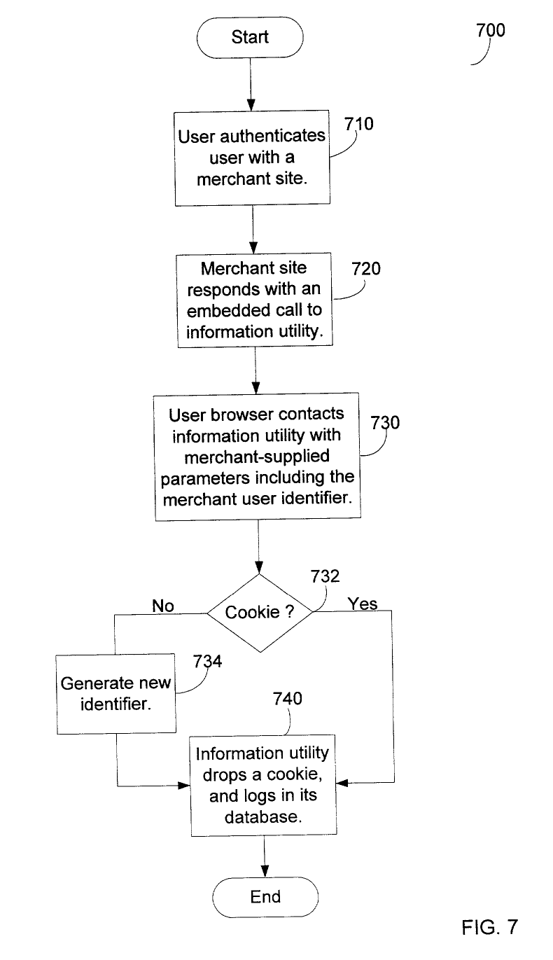

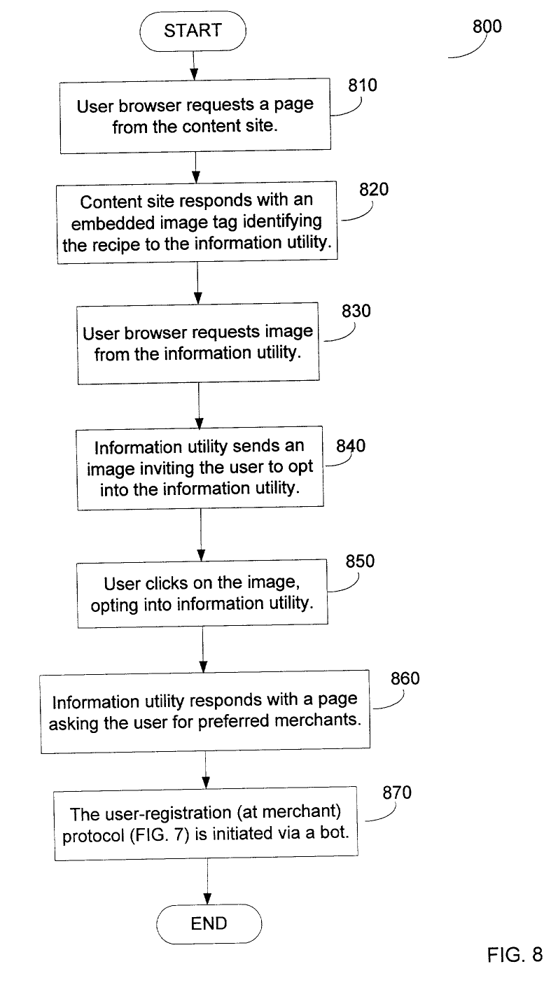

Merchant site user registration 700 is illustrated in FIG. 7. First, the user authenticates the user with a merchant site 20 (710). During the interaction of the user with the browser 601, a user eventually successfully identifies him or herself by logging on. In one aspect, the user may log onto a sign-up page that requests user information. This step indicates the HTTP POST of the transmission of the login information from the user browser 610 to the merchant site 20.

Next, the merchant site 20 responds with an HTML reply acknowledging the successful login. (720) Embedded in this page is an image reference to the information utility 250 of the form

<img src=“merchantimage.informationutility.com?merchant=1&user=2”>

where “1” is an example pre-assigned merchant identifier (established by the information utility 250 administrator) and “2” is an example merchant user identifier. This user identifier is an arbitrary string opaque to the information utility 250.

In one aspect, the page may embed an image reference to the merchant system of the form

<img src=“image.merchant.com?user=2”>

As the user browser 610 renders the HTML reply, it may requests the image from the information utility 250 and from the merchant site 20 server. The merchant server responding to this message may drop a merchant cookie (merchant-id=2). When the user visits the merchant site 20, this cookie can be used to identify the user.

Next, the information utility 250 receives a request from the user browser 610 for an image. The user browser 610 contacts the information utility 250 with merchant supplied parameters including the mui. (730) The information utility 250 then determines if an information utility 250 cookie exists. If it does, then information utility 250 drops a cookie, and logs the new user in its database server 640a (FIG. 6). (740) No attached cookie implies that this request comes from a new user. In that event, the handler generates a new information utility 250 user object, assigns an identifier, say “3,” and saves a tuple in P (734). Thus, the triple (informationutility-id=3, merchant-id=1, merchant-user-id=2) is saved. A single-pixel image is returned as the response to the request. Then the information utility 250 drops a cookie and logs the user into its database (740) a cookie (informationutility-id=3) is dropped at the user browser 610.

User Registration Phase-Content

For registration from the content site 10, a seven-step protocol is used as shown in FIG. 8. First, the user browser 601 requests a page from the content site 10 (810). An HTML page is returned as the answer to the request. (820) Embedded in the page is an image reference to the information utility 250, for example of the form:

<a href=“contentclick.informationutility.com?content=4&recipe=5”>

<img src =“contentimage.informationutility.com?content=4&recipe=5”></a>

The content identifier “4” identifies the content site 10 to the information utility 250. (This value is assigned by the information utility 250.) The recipe identifier “5” identifiers a recipe 410 at the content site 10. (The content site 10 assigns this value.) As the browser renders the HTML, it requests the image from the information utility 250. (830) The image server (for example, content image handler, Image 1, 640c, FIG. 6) receives the request (without a cookie) and generates an image inviting the user to click on the image to join the information utility 250. (840) The image may consist of registration icon 425 of FIG. 4a (“Try Shopping Online!”). The user clicks on the image, sending a request to the image sever (for example, 640c, FIG. 6) (without a cookie). (850) The image server (for example 640c) responds with a sequence of page interactions where the user specifies the preferred merchant site 20, user name, zip code, etc. (860) For example, the user may be presented with the sign-on page 478 of FIG. 4c. As shown in FIG. 4c, the user may be given the option of specifying his or her username 479, password 481, zip code 483, and preferred online grocer 485.

Referring again to FIG. 8, the previous merchant site 20 user registration protocol is invoked for the preferred merchant via a bot. (870) (The bot mimics the actions of the browser in the merchant site 20 user registration protocol.) The resulting HTML is passed back to the user as the last reply. This protocol drops the information utility 250 cookie on the browser (informationutility-id=3) and the merchant site 20 cookie.

In construction of P, there may be a number of complications.

Cookies may be deleted from a browser at any time. The information utility 250 relies on the absence of a cookie to indicate a new user. In the case that a user registers and then deletes the cookies in a browser, the information utility 250 will operate as if the user is a new user, until the merchant registration protocol (740 or 870). During this step, the information utility 250 looks up the merchant user identifier in P and finds a different information utility 250 user identifier. This creates a situation of “conflicting user identifiers.” In this case, existing user identifier is used when dropping the cookie and no new tuple is added to P (Rule 1).

A separate complication may arise from a user using two different browsers to access the same merchant. (For example, a browser 610a at work and a browser 610i at home may be used by the same user.) After registering with browser 610a and then switching to browser 610i, the user is treated as a new user when registering browser 610i, until Step 740/870. By using the existing user identifier when dropping the cookie and by adding an existing tuple to P, the same cookie is dropped at both browsers 610a and 610i.

When a user signs up with a second merchant site 20, another tuple is added to P to represent the second merchant site 20. The existing user identifier is used. In an extended example, a user signing up at merchant “2” that returns a merchant user identifier “3” would add the tuple (informationutility-id=3, merchant-id=2, merchant-user-id=3) to relation P.

Effectively a new task is added to step 740/870:

An attached cookie implies that this request comes from an existing user. The handler uses the existing identifier, say “3”, and saves a tuple in P. Thus, the triple (informationutility-id=3, merchant-id=1, merchant-user-id=2) is saved. A single-pixel image is returned as the response to the request. In addition, a cookie (informationutility-id=3) is dropped at the user browser 610a or 610i.

In another example, a user signs up with merchant “1” using browser 610a and inserting tuple (3,1,2) into P. The same user may sign up with merchant “2” using browser 610i and inserting tuple (4,2,3) in P. (The above protocol is simply executed twice here.) These two users will be treated as two independent users. However, subsequently, when the user signs up with merchant “2” using browser 610a or merchant “1” using browser 610i, the two users are collapsed into a single user. This collapsing operation is accomplished by replacing the existing cookie with the matched information utility 951 identifier and all tuples containing the existing cookie identifier are replaced with the matched information utility 250 identifier in P (Rule 2).

Applying Rule 2 produces (informationutility-id=3, content=1, recipe=2) and (informationutility-id=3, content=2, recipe=3) in P when the user signs up with merchant “1” using browser 610i, with the cookie (informationutility-id=3) on both browsers. Repeated application of Rule 2 merges multiple users into the same information utility 250 identifier.

This protocol introduces some security concerns, since cookies delivered from a browser may be stolen or systematically enumerated. Requiring re-authentication before any transaction blocks the effectiveness of stolen cookies. Selecting randomly from a very large space of potential identifiers, say, 2¹²⁸, blocks the effectiveness of systematically enumerating cookies.

A number of embodiments of the invention have been described. Nevertheless, it will be understood that various modifications may be made without departing from the spirit and scope of the invention. For example, the invention has been discussed in the context of internet websites, but is not limited to such sites. Instead, the same concept may apply to any electronic network involving communication between two or more entities, including wireless networks or networks including wireless communications via voice or tone. Although the invention has been described in terms of using a “browser,” it should be understood that the term browser is to be applied broadly to include any utility for accessing electronic information. And, although the invention has been described in terms of HTML language and HTTP protocols, it applies equally as well to any mechanism for transporting information.

The invention is also not limited to communications between merchants and content providers, but may apply equally as well to communications between any applications including: email, word processing, databases, spreadsheets, presentations, scheduling, bookkeeping, etc. The invention has been described as including a database. The database may be a single database, or may be one or more databases. The invention has been described in terms of certain servers. The functions of the servers may be achieved by consolidating or dividing servers, or by allocating servers in any manner.

Accordingly, other embodiments are within the scope of the following claims.

What is claimed is:

1. A system for facilitating communication between two or more sites, the system comprising:
an information utility operable to enable communication between a first site and a second site; and
a user registration system coupled to the information utility, the user registration system operable to enable the first and second sites to identify users without sharing user information.

2. The system of claim 1, wherein the user registration system is operable to enable the first and second sites to identify users by dropping a cookie at the user browser, the cookie maintaining the user information.

3. A information utility for facilitating communication between two or more sites, the information utility, comprising:
a database operable to store user information; and
a user registration system operable to enable users to register with an information utility.

4. The information utility of claim 3, wherein the user registrations system is operable to drop a cookie on the user's browser, the cookie maintaining user information.

5. The information utility of claim 3, wherein the user information indicates a state of one or more transactions issued by the user.

6. The information utility of claim 3, wherein the user information comprises information indicative of the user's identification.

7. The information utility of claim 3, wherein the information utility is operable to route registered users to a merchant site.

8. The information utility of claim 3, wherein the information utility is operable to route registered users to a transaction management server and issue a transaction at a content site.

9. In a electronic message transmission system, a method for managing user identifications between entities, the method comprising:
authenticating a user at an information utility;
upon registering the absence of a browser cookie, dropping an cookie in the user browser, wherein the browser cookie is operable to identify the user as a registered user upon subsequent access to the information utility; and
providing a platform for the user to register with the information utility.

10. The method of claim 9, further comprising:
upon detecting that a browser cookie does not exist and upon detecting the presence of a merchant cookie, dropping a cookie in the browser using the user identifier in the merchant cookie.

11. The method of claim 9, further comprising:
upon detecting two browser cookies for a single user, replacing the existing cookies with a single cookie.
